(19) United States
(12) Patent Application Publication
(10) Pub. No.: US 2009/0187561 A1
(43) Pub. Date: Jul. 23, 2009

(54) CONTENT SEARCH METHOD AND SYSTEM

(75) Inventors: Hyun-Mi PARK, Suwon-si (KR); Deok-Won Kim, Incheon (KR); Sin-Ae Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/348,635

(22) Filed: Jan. 5, 2009

(30) Foreign Application Priority Data
Jan. 23, 2008 (KR) 10-2008-0007251

(51) Int. Cl. G06F 17/30

(52) U.S. Cl. 707/5; 707/3; 707/E17.014; 707/E17.017

(57) ABSTRACT

Provided are a content search method and system, and more particularly, a content search method and system which enable a user to easily access desired search results by reducing the need to input a keyword again or navigate through pages of search results. The content search method includes: receiving a keyword and extracting a list of contents which correspond to the received keyword; adjusting relative weights of one or more attribute information of the contents by using a user interface which can adjust the relative weights; and sequentially listing the contents based on the adjusted weights and providing the contents accordingly.

### CROSS-REFERENCE TO RELATED APPLICATION

This application claims priority from Korean Patent Application No. 10-2008-0007251 filed on Jan. 23, 2008 in the Korean Intellectual Property Office, the disclosure of which is incorporated herein by reference in its entirety.

### BACKGROUND OF THE INVENTION

1. Field of the Invention

The present invention relates to content search, and more particularly, to a content search method and system which enable a user to easily access desired search results by reducing the need to input a keyword again or navigate through pages of search results.

2. Description of the Related Art

Conventional Internet-based content search services require users to access content search site servers using their own systems (such as personal computers (PCs) or mobile communications terminals) and input keywords to obtain necessary search results.

However, as the number of content providers and the amount of contents provided by the content providers increase, it is becoming more difficult for users of the conventional Internet-based content search services to find desired search results at one time.

That is, in order to find desired contents from search results, which were obtained by using a keyword, a user has to change sorting conditions several times or input a new keyword again.

### SUMMARY OF THE INVENTION

The present invention provides a content search method and system which enable a user to easily access desired search results by reducing the need to input a keyword again or navigate through pages of search results.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a content search method including: receiving a keyword and extracting a list of contents which correspond to the received keyword; adjusting relative weights of one or more attribute information of the contents by using a user interface which can adjust the relative weights; and sequentially listing the contents based on the adjusted weights and providing the contents accordingly.

According to another aspect of the present invention, there is provided a content search system including: a content use apparatus which receives a keyword from a user and provides a user interface which can adjust relative weights of one or more attribute information of contents; and a content search apparatus which extracts a list of contents which correspond to the keyword received from the content use apparatus, sequentially lists the contents based on the relative weights which are adjusted by the user interface, and provides the contents to the content use apparatus accordingly.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates the configuration of a moving-image search system according to an exemplary embodiment of the present invention;

FIG. 2 illustrates an example of a graphic user interface (GUI) which can adjust relative weights for attribute information of moving-image files;

FIG. 3 illustrates another example of a GUI which can adjust relative weights for attribute information of moving-image files;

FIGS. 4A through 4C illustrate examples of relative proportions of attribute information regions in a weight control interface which have been adjusted by moving control regions of the weight control interface; and

FIG. 5 is a flowchart illustrating a moving-image search method according to an exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described with reference to block diagrams or flowchart illustrations. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order shown. For example, two blocks shown in succession may in fact be executed substantially concurrently or the blocks may sometimes be executed in the reverse order, depending upon the functionality involved.

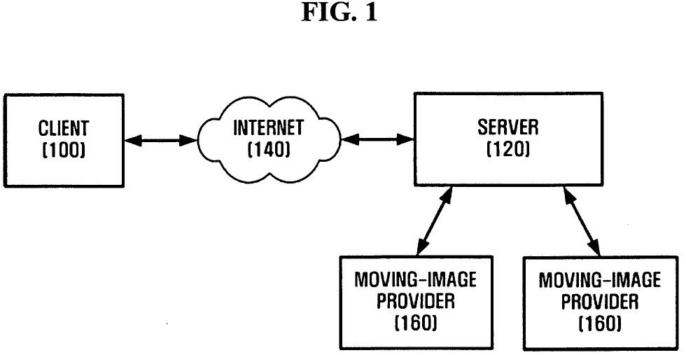

FIG. 1 illustrates the configuration of a moving-image search system according to an exemplary embodiment of the present invention.

Referring to FIG. 1, the moving-image search system is based on the Internet 140. However, the present invention is not limited thereto. That is, the moving-image search system can be based on any environment in which a large number of moving images are available and in which the moving images can be searched for.

In the present embodiment, moving images are used as an example of contents that are to be searched for. However, the contents that are to be searched for may also be texts, music, photographs, images, or the like.

The moving-image search system according to the present embodiment includes a client 100 and a server 120. The client 100 is an apparatus for using moving images, such as a personal computer (PC), wherein the apparatus accesses online moving-image search sites. The server 120 is an apparatus for searching for moving images, wherein the apparatus searches for moving images by using a search word, which is received from the client via the Internet 140, and provides a list of found moving images to the client 100.

Specifically, at the client 100, a user activates an Internet access program, such as ‘Internet Explorer,’ and enters and executes a uniform resource locator (URL) of a moving-image search site.

Then, the client 100 is connected to the moving-image search site by the Internet 140. Here, the server 120, which manages the moving-image search site, provides a moving-image search menu screen to the client 100, and the search menu screen is displayed on a display of the client 100. Thus, on the search menu screen displayed on the display of the client 100, the user enters a keyword to search for desired moving images and executes the search. For example, when the user wants to find moving images corresponding to a keyword ‘infinite challenge,’ the user may enter the keyword on the search menu screen and execute the search.

Next, the keyword is input to the server 120 via the Internet 140. Then, the server 120 searches moving-image files, which were found, indexed and stored therein in advance, by using the received keyword and provides search results to the client 100 via the Internet 140. Accordingly, the client 100 displays the search results on the search menu screen.

The user of the client 100 checks the search results, that is, a list of moving-image files related to the keyword ‘infinite challenge,’ displayed on the search menu screen and clicks and views the moving-image files as desired.

Although only one server 120 and only one client 100 are illustrated in FIG. 1 to describe the basic configuration of the moving-image search system, the present invention is not limited thereto. Thus, the moving-image search system may include a plurality of servers and a plurality of clients which are identical to those illustrated in FIG. 1.

Each of the moving-image files, which were found, indexed and stored in the server 120 in advance, may have at least one attribute information, a value (hereinafter, referred to as ‘attribute value’) corresponding to the attribute information, and priority information of moving-image providers 160 (for example, web sites) which provide the moving-image files, respectively.

The attribute information may be used as a standard for sorting moving images. Examples of the attribute information may include, but is not limited to, ‘popularity,’ ‘reliability,’ ‘recency’, and ‘familiarity.’

The attribute information ‘popularity’ may be a standard for extracting popular moving images which have been frequently viewed or rank high in popularity. The attribute information ‘reliability’ may be a standard for extracting moving images produced by publicly reliable producers such as broadcasting stations and newspapers. In addition, the attribute information ‘recency’ may be a standard for extracting recent moving images, and the attribute information ‘familiarity’ may be a standard for extracting moving images which are registered with sites frequently visited by the user.

An attribute value indicates the relative superiority of each moving image for each attribute information and may be 0 to 100. For example, for the attribute information ‘popularity’, a moving image ‘A’ may have an attribute value of 100, and a moving image ‘B’ may have an attribute value of 1. In this case, the moving image ‘A’ is superior to the moving image ‘B’ in terms of the attribute information ‘popularity.’ If the attribute value is zero, no attribute information corresponding to the attribute value is available.

The priority information of each of the moving-image providers 160 may have a value of zero to one. The reason why the moving-image files have the priority information of the corresponding moving-image providers 160, respectively, is that the number of moving-image providers, which are to be searched by the server 120, changes each time and that the moving-image providers 160 have different levels of recognition. Thus, the priority information of the moving-image providers 160 is added to the moving-image files, respectively, for more accurate search. In addition, the sum of values representing the priority information of the entire moving-image providers 160, which are to be searched by the server 120, is set to one.

A graphic user interface (GUI) may be displayed on the client 100. The GUI may adjust relative weights for attribute information of moving-image files and may be provided in a widget form.

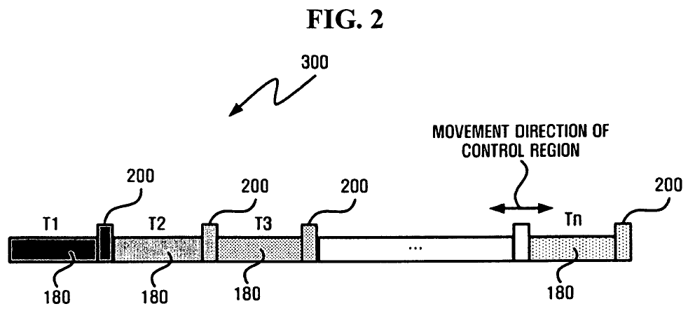

FIG. 2 illustrates an example of a GUI which can adjust relative weights for attribute information of moving-image files.

The GUI (hereinafter, referred to as a ‘weight control interface 300’), which can adjust the relative weight for each attribute information, may be shaped like a bar having a predetermined length.

The weight control interface 300 may include one or more attribute information regions 180 and one or more control regions 200. Each of the attribute information regions 180 represents corresponding attribute information, and each of the control regions 200 is used to adjust a relative proportion of each of the attribute information regions 180 in the weight control interface 300. In FIG. 2, the attribute information regions 180 and the control regions 200 are all bar-shaped. However, the present invention is not limited thereto.

The attribute information regions 180 may be represented in different colors so that the attribute information corresponding to the attribute information regions 180 can be distinguished from one another. In addition, the control regions 200 corresponding to the attribute information regions 180, respectively, may also be represented in different colors.

Referring to FIG. 2, if the user moves one of the control regions 200 to the right or left, the lengths of two attribute information regions 180 corresponding to the moved control region 200 are adjusted. Accordingly, relative proportions of the two corresponding attribute information regions 180 in the weight control interface 300 (that is, ratios of the lengths of the two corresponding attribute information regions 180 to the length of the weight control interface 300) can be adjusted.

While the entire length of the weight control interface 300 is fixed, only the lengths of the attribute information regions 180 may be adjusted relative to one another. In this case, the sum of the relative proportions of the attribute information regions 180 in the weight control interface 300 is 100%. That is, as illustrated in FIG. 2, if the attribute information regions 180 are T1, T2, . . . , Tn and if the relative proportions of the attribute information regions 180 are Len_T1, Len_T2, . . . , Len_Tn, the sum of the relative proportions of the attribute information regions 180 is Len_T1+Len_T2+ . . . +Len_Tn=100.

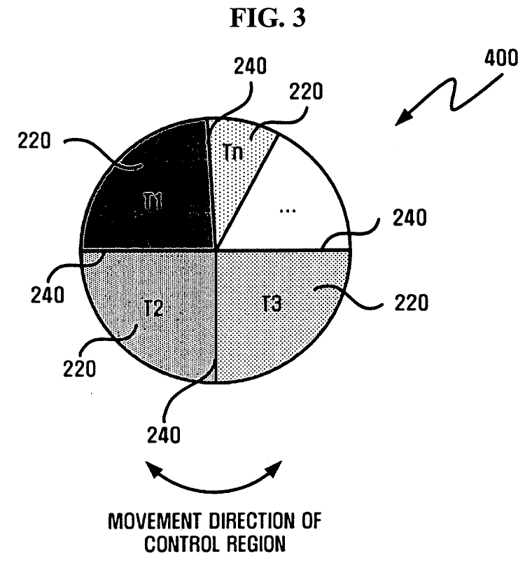

FIG. 3 illustrates another example of a GUI which can adjust relative weights for attribute information of moving-image files.

While the weight control interface 300 of FIG. 2 adjusts the relative weight of each attribute information in consideration of length, a weight control interface 400 of FIG. 3 adjusts the relative weight of each attribute information in consideration of size.

The weight control interface 400 may be shaped like a circle having a predetermined size. One or more attribute information regions 220 corresponding to one or more attribute information, respectively, may be pie-shaped and represented in different colors. However, the present invention is not limited thereto.

Referring to FIG. 3, if a user rotates one of control regions 240, the sizes of two attribute information regions 220 corresponding to the rotated control region 240 are adjusted. Accordingly, relative proportions of the two corresponding attribute information regions 220 in the weight control interface 400 (that is, ratios of the sizes of the two corresponding attribute information regions 220 to the size of the weight control interface 400) can be adjusted.

While the entire size of the weight control interface 400 is fixed, only the sizes of the attribute information regions 220 may be adjusted relative to one another. In this case, the sum of the relative proportions of the attribute information regions 220 in the weight control interface 400 is 100%. That is, as illustrated in FIG. 3, if the attribute information regions 220 are T1, T2, . . . , Tn and if the relative proportions of the attribute information regions 220 are Area_T1, Area_T2, . . . , Area_Tn, the sum of the relative proportions of the attribute information regions 220 is Area_T1+Area_T2+ . . . +Area_Tn=100.

In order to move the control regions 200 and 240, the user may use an input unit such as a mouse, a keypad, or a touch pad.

The server 120 may calculate the relative proportions of the attribute information regions 180 or 220 in the weight control interface 300 or 400 based on the result of the user's manipulation of the weight control interface 300 or 400, assign a different weight to each attribute information based on the calculated relative proportions, and determine the order, in which search results are to be listed, based on the weighted attribute information. Thus, the order in which moving images found by using a keyword are listed may vary according to the result of manipulating the weight control interface 300 or 400. When initially inputting a keyword, the user may also adjust a weight of each attribute information.

The position of each moving-image file in a list of moving-image files, which were found by using a keyword, may be a rank. In addition, attribute values of attribute information may be V_T1, V_T2, . . . , V_Tn, and relative proportions of the attribute information regions 180 or 220 may be R_T1, R_T2, . . . , R_Tn. In this case, the rank may be defined by Equation (1) below.

rank=V_{—}T1×R_{—}T1+V_{—}T2×R_{—}T2+ . . . +V_{—}Tn×R_{—}Tn (1).

Each moving-image file has a rank value. If rank values of M moving-image files found by using a keyword are rank_1, rank_2, . . . , rank_M, respectively, the server 120 compares rank_1, rank_2, . . . , rank_M, which are calculated using Equation (1), in real time and determines the order in which search results, that is, the M moving-image files, are to be listed. Then, the server 120 provides the search results, which are listed in the determined order, to the client 100.

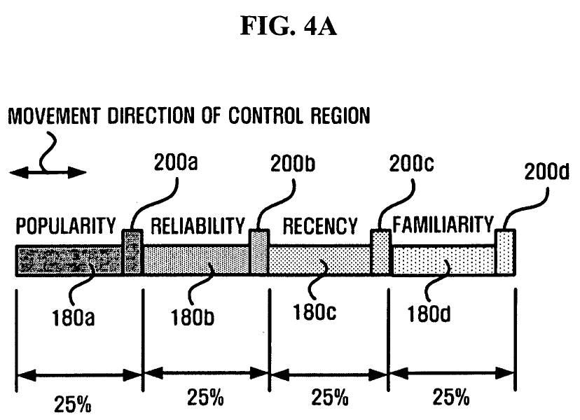

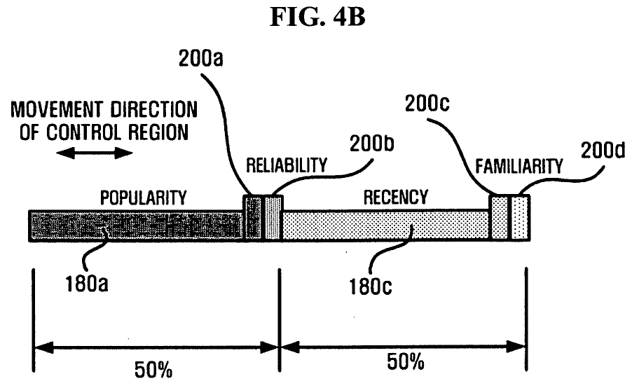

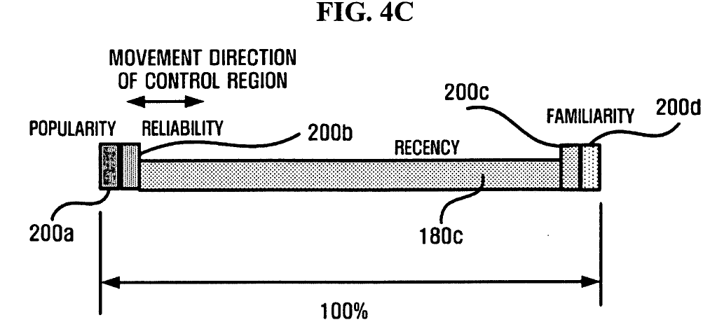

When the relative proportions of the attribute information regions 180 or 220 included in the weight control interface 300 or 400 are all equal, that is, when all attribute information has the same weight, Equation (1) is not applied (see FIG. 4A).

FIGS. 4A through 4C illustrate examples of relative proportions of attribute information regions 180a through 180d in the weight control interface 300 (see FIG. 2) which have been adjusted by moving control regions 200a through 200d of the weight control interface 300.

Referring to FIG. 4A, relative proportions of the four attribute information regions (the attribute information region 180a representing attribute information ‘popularity,’ the attribute information region 180b representing attribute information ‘reliability,’ the attribute information region 180c representing attribute information ‘recency,’ and the attribute information region 180d representing attribute information ‘familiarity’) in the weight control interface 300 are 25%, respectively. In this case, the server 120 may not apply a particular search standard to searching moving-image. Thus, search results may be listed in order of relevance to a keyword, which was used, and provided to the client 100.

Referring to FIG. 4B, the proportion of the attribute information region 180a, which represents the attribute information ‘popularity,’ and that of the attribute information region 180b, which represents the attribute information ‘recency,’ are 50%, respectively. When receiving this information, the server 120 lists search results in order of popularity and recency and provides the search results to the client 100 accordingly.

Referring to FIG. 4C, the proportion of the attribute information region 180c, which represents the attribute information ‘recency,’ is 100%. When receiving this information, the server 120 provides search results, which are listed in order of recency, to the client 100.

Table 1 below shows an example of attribute values of the attribute information ‘popularity,’ ‘reliability,’ ‘recency,’ and ‘familiarity’ for each of four moving-image files ‘A,’ ‘B,’ ‘C’ and ‘D’ which were found by using a keyword.

TABLE 1

| Type of | Attribute Information | | | |
|---|---|---|---|---|
| Moving Image | Popularity | Reliability | Recency | Familiarity |
| A | 100 | 0 | 30 | 20 |
| B | 80 | 40 | 10 | 50 |
| C | 10 | 70 | 100 | 30 |
| D | 20 | 20 | 50 | 100 |

If a weight for each attribute information has been adjusted as illustrated in FIG. 4B and if rank values of the moving-image files ‘A,’ ‘B,’ ‘C’ and ‘D’ are rank_A, rank_B, rank_C and rank_D, the rank values calculated by using Equation (1) may be as follows.

rank_{—}A=100×0.5+30×0.5=65,

rank_{—}B=80×0.5+10×0.5=45,

rank_{—}C=10×0.5+100×0.5=55,

rank_{—}D=20×0.5+50×0.5=35

Therefore, the server 120 lists search results in order of highest to lowest rank value. That is, the server 120 lists the moving-image files ‘A,’ ‘B,’ ‘C’ and ‘D’ in order of A, C, B and D and provides them to the server 120 accordingly.

The server 120 may also consider the priority information of the moving-image providers 160 when searching for moving images.

For example, the priority information of each of the moving-image providers 160 may be P_site, and the position of each moving-image file in a list of M moving-image files, which were found by using a keyword, may be a rank. In addition, attribute values of attribute information may be V_T1, V_T2, . . . , V_Tn, and relative proportions of attribute information regions may be R_T1, R_T2, . . . , R_Tn. In this case, the rank may be defined by Equation (2) below.

rank=(V_{—}T1×R_{—}T1+V_{—}T2×R_{—}T2+ . . . +V_{—}Tn×R_{—}Tn)×P_site (2).

If rank values of the M moving-image files found by using the keyword are rank_1, rank_2, . . . , rank_M, respectively, the server 120 compares rank_1, rank_2, . . . , rank_M in real time and determines the order in which search results, that is, the M moving-image files, are to be listed. Then, the server 120 provides the search results, which are listed in the determined order, to the client 100.

Table 2 below shows an example of the priority information of moving-image providers which respectively provide the moving-image files ‘A,’ ‘B,’ ‘C’ and ‘D’ shown in Table 1. In this example, it is assumed that there are four moving-image providers to be searched by the server 120, that the moving-image providers are W1 through W4, and that P_W1=0.3, P_W2=0.2, P_W3=0.1, P_W4=0.4. Thus, the sum of the priority information of the moving-image providers, which are to be searched by the server 120, is one. That is, P_W1+P_W2+P_W3+P_W4=1.

TABLE 2

| Type of Moving Image | P_site |
|---|---|
| A | 0.3 |
| B | 0.1 |
| C | 0.3 |
| D | 0.4 |

If the weight of each attribute information has been adjusted as shown in FIG. 4B and if the rank values of the moving-image files ‘A,’ ‘B,’ ‘C’ and ‘D’ are rank_A, rank_B, rank_C and rank_D, the rank values calculated using Equation (2) may be as follows.

rank_{—}A=(100×0.5+30×0.5)×0.3=19.5,

rank_{—}B=(80×0.5+10×0.5)×0.1=4.5,

rank_{—}C=(10×0.5+100×0.5)×0.3=16.5,

rank_{—}D=(20×0.5+50×0.5)×0.4=14

Therefore, the server 120 lists search results in order of highest to lowest rank value. That is, the server 120 lists the moving-image files ‘A,’ ‘B,’ ‘C’ and ‘D’ in order of A, C, D and B and provides them to the server 120 accordingly.

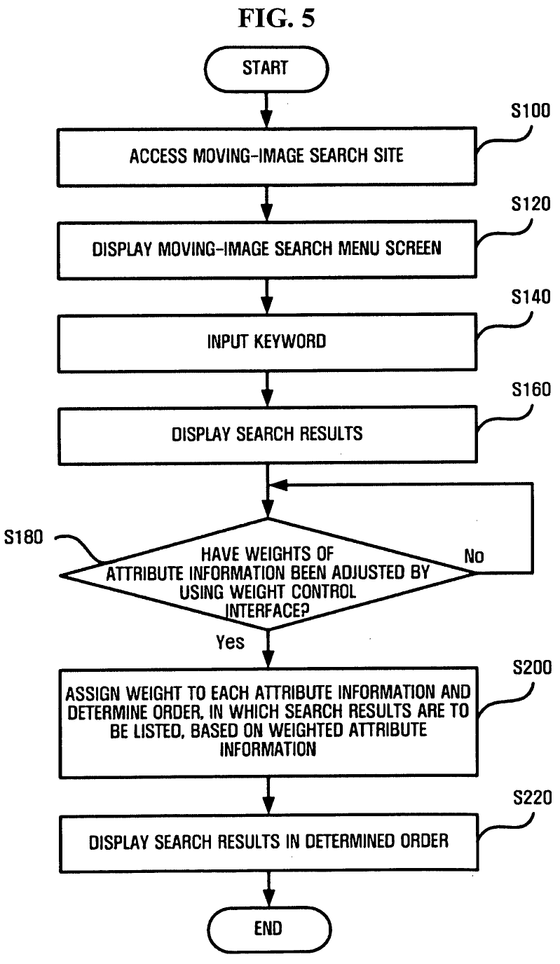

FIG. 5 is a flowchart illustrating a moving-image search method according to an exemplary embodiment of the present invention.

Referring to FIG. 5, at the client 100, a user activates an Internet access program and enters and executes a URL of a moving-image search site which provides a moving-image search service.

Then, the client 100 accesses the moving-image search site through the Internet 140 (operation S100). Here, the server 120, which manages the moving-image search site, provides a moving-image search menu screen to the client 100, and the client 100 displays the moving-image search menu screen on the display thereof (operation S120).

On the moving-image search menu screen displayed on the display of the client 100, the user inputs a keyword to search for a desired moving image and executes the search (operation S140).

Accordingly, the server 120 searches for moving-image files corresponding to the keyword, which is received from the client 100, and provides found moving-image files on the moving-image search menu screen of the client 100 (operation S160).

If the user of the client 100 wants to rearrange the moving-image files based on attribute information of the moving-image files, the user adjusts the relative proportions of the attribute information regions 180 or 220 of the weight control interface 300 or 400 of FIG. 2 or 3 (operation S180).

Accordingly, the server 120 assigns different weights to the attribute information based on the relative proportions of the attribute information regions 180 or 220, determines the order in which the found moving-image files are to be listed (operation S200), and provides the moving-image files, which are listed in the determined order, to the client 100 (operation S220). To this end, the server 120 may use Equation (1) or (2), which will not be described again since a detailed description thereof has been made above.

Although FIG. 5 illustrates a case where weight adjustment is performed after search results, which were obtained by using a keyword received from the client 100, are displayed on the moving-image search menu screen, inputting a keyword and adjusting weights may also be performed simultaneously at the client 100.

When the moving-image search method of FIG. 5 is used, the need to input a keyword again or navigate through pages of search results can be reduced, and thus the user can easily access desired search results. Consequently, search efficiency can be enhanced.

As described above, a content search method and system according to the present invention enable a user to easily access desired search results by reducing the need to input a keyword again or navigate through pages of search results.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A content search method comprising:
receiving a keyword and extracting a list of contents which correspond to the received keyword;
adjusting relative weights of one or more attribute information of the contents by using a user interface which can adjust the relative weights; and
sequentially listing the contents based on the adjusted weights and providing the contents accordingly.

2. The method of claim 1, wherein the attribute information is a standard for sorting the contents.

3. The method of claim 2, wherein the attribute information comprises at least one of information used to extract popular contents, which have been frequently viewed or rank high in popularity, information used to extract contents produced by publicly reliable producers, information used to extract recent contents, and information used to extract contents which are registered with content providers frequently visited by a user.

4. The method of claim 1, wherein each of the relative weights of the attribute information is represented by a percentage, and a sum of the relative weights of the attribute information is 100%.

5. The method of claim 1, wherein the user interface comprises one or more attribute information regions, which represent the attribute information, respectively, and have different colors corresponding to the attribute information, respectively, and one or more control regions which are used to adjust relative proportions of the attribute information regions in the user interface, wherein the adjusting of the relative weights comprises adjusting the relative proportions of the attribute information regions in the user interface.

6. The method of claim 5, wherein the control regions are used to adjust the relative proportions of the attribute information regions in the user interface in terms of length or size.

7. The method of claim 1, wherein each content has an attribute value indicating a relative superiority for each attribute information, and the sequential listing of the contents and the providing of the contents comprises sequentially listing the contents based on rank which are calculated for the contents, respectively, by using
rank=V_{—}T1×R_{—}T1+V_{—}T2×R_{—}T2+ . . . +V_{—}Tn×R_{—}Tn, (1)
where rank indicates a position of each content in a list of the contents, T1, T2, . . . , Tn indicate the attribute information, V_T1, V_T2, . . . , V_Tn indicate attribute values of the attribute information, and R_T1, R_T2, . . . , R_Tn indicate the relative weights of the attribute information.

8. The method of claim 1, wherein each content has priority information of a corresponding content provider, and the sequential listing of the contents and the providing of the contents comprises sequentially listing the contents based on rank which are calculated for the contents, respectively, by using
rank=(V_{—}T1×R_{—}T1+V_{—}T2×R_{—}T2+ . . . +V_{—}Tn×R_{—}Tn)×P_site, (2)
where rank indicates a position of each content in the list of the contents, T1, T2, . . . , Tn indicate the attribute information, V_T1, V_T2, . . . , V_Tn indicate the attribute values of the attribute information, R_T1, R_T2, . . . , R_Tn indicate the relative weights of the attribute information, and P_site indicates the priority information of each content provider.

9. The method of claim 8, wherein the priority information of each content provider has a value of zero to one, and a sum of the priority information of content providers, which are to be searched, is one.

10. The method of claim 7, wherein the sequential listing of the contents based on the rank comprises listing the contents in order of highest to lowest rank value.

11. The method of claim 7, wherein the sequential listing of the contents based on the rank comprises listing the contents in order of highest to lowest rank value.

12. The method of claim 5, wherein the sequential listing of the contents and the providing of the contents comprises listing the contents, which correspond to the received keyword, when the adjusted relative proportions of the attribute information regions are all equal.

13. A content search system comprising:
a content use apparatus which receives a keyword from a user and provides a user interface which can adjust relative weights of one or more attribute information of contents; and
a content search apparatus which extracts a list of contents which correspond to the keyword received from the content use apparatus, sequentially lists the contents based on the relative weights which are adjusted by the user interface, and provides the contents to the content use apparatus accordingly.

14. The system of claim 13, wherein the attribute information is a standard for sorting the contents.

15. The apparatus of claim 14, wherein the attribute information comprises at least one of information used to extract popular contents, which have been frequently viewed or rank high in popularity, information used to extract contents produced by publicly reliable producers, information used to extract recent contents, and information used to extract contents which are registered with content providers frequently visited by the user.

16. The system of claim 13, wherein each of the relative weights of the attribute information is represented by a percentage, and a sum of the relative weights of the attribute information is 100%.

17. The system of claim 13, wherein the user interface comprises one or more attribute information regions, which represent the attribute information, respectively, and have different colors corresponding to the attribute information, respectively, and one or more control regions which are used to adjust relative proportions of the attribute information regions in the user interface, wherein the relative weights of the attribute information are adjusted by adjusting the relative proportions of the attribute information regions in the user interface.

18. The system of claim 17, wherein the control regions are used to adjust the relative proportions of the attribute information regions in the user interface in terms of length or size.

19. The system of claim 13, wherein each content has an attribute value indicating a relative superiority for each attribute information, and the content search apparatus sequentially lists the contents based on rank values which are calculated for the contents, respectively, by using
rank=V_{—}T1×R_{—}T1+V_{—}T2×R_{—}T2+ . . . +V_{—}Tn×R_{—}Tn, (1)
where rank indicates a position of each content in a list of the contents, T1, T2, . . . , Tn indicate the attribute information, V_T1, V_T2, . . . , V_Tn indicate attribute values of the attribute information, and R_T1, R_T2, . . . , R_Tn indicate the relative weights of the attribute information.

20. The system of claim 13, wherein each content has priority information of a corresponding content provider, and the content search apparatus sequentially lists the contents based on rank values which are calculated for the contents, respectively, by using
rank=(V_{—}T1×R_{—}T1+V_{—}T2×R_{—}T2+ . . . +V_{—}Tn×R_{—}Tn)×P_site, (2)
where rank indicates the position of each content in the list of the contents, T1, T2, . . . , Tn indicate the attribute information, V_T1, V_T2, . . . , V_Tn indicate the attribute values of the attribute information, R_T1, R_T2, . . . , R_Tn indicate the relative weights of the attribute information, and P_site indicates the priority information of each content provider.

21. The system of claim 20, wherein the priority information of each content provider has a value of zero to one, and a sum of the priority information of content providers, which are to be searched, is one.

22. The system of claim 19, wherein the content search apparatus lists the contents in order of highest to lowest rank value.

23. The system of claim 20, wherein the content search apparatus lists the contents in order of highest to lowest rank value.

24. The system of claim 17, wherein the content search apparatus lists the contents, which correspond to the received keyword, when the adjusted relative proportions of the attribute information regions are all equal.
